(19) United States
(12) Patent Application Publication
(10) Pub. No.: US 2015/0213830 A1
(43) Pub. Date: Jul. 30, 2015

(54) SPINDLE MOTOR AND HARD DISK DRIVE INCLUDING THE SAME

(71) Applicant: SAMSUNG ELECTRO-MECHANICS CO., LTD., Suwon-Si (KR)

(72) Inventor: Hoon Hee HAN, Suwon-Si (KR)

(73) Assignee: SAMSUNG ELECTRO-MECHANICS CO., LTD., Suwon-Si (KR)

(21) Appl. No.: 14/582,184

(22) Filed: Dec. 24, 2014

(30) Foreign Application Priority Data
Jan. 7, 2014 (KR) 10-2014-0001869

(51) Int. Cl. G11B 19/20; H02K 5/10

(52) U.S. Cl. CPC G11B 19/2009; H02K 5/10

(57) ABSTRACT

There is provided a spindle motor including: a shaft having a lower end portion fixed to a lower thrust member and having a flange part disposed at an upper end portion thereof; a rotating member rotating around the shaft and including a sleeve part disposed between the lower thrust member and the flange part; a sealing member fixed to an outer peripheral surface of the flange part of the shaft; a cap member fixed to the rotating member to be disposed to face the sealing member; and a cover member having a region surrounding amounting hole seated on an upper surface of the flange part of the shaft and forming a labyrinth seal together with the cap member.

### CROSS-REFERENCE TO RELATED APPLICATION

This application claims the benefit of Korean Patent Application No. 10-2014-0001869 filed on Jan. 7, 2014, with the Korean Intellectual Property Office, the disclosure of which is incorporated herein by reference.

### BACKGROUND

The present disclosure relates to a spindle motor and a hard disk drive including the same.

A compact spindle motor used in a hard disk drive (HDD) is generally provided with a hydrodynamic bearing assembly, and a bearing clearance formed between a fixed part and a rotating part of the hydrodynamic bearing assembly is filled with a lubricating fluid such as oil. The oil filled in the bearing clearance generates fluid dynamic pressure while being compressed, thereby rotatably supporting the rotating part.

In addition, the above-mentioned bearing clearance is formed in a clearance formed by the rotating part and the fixed part.

Meanwhile, recently, a fixed shaft-type spindle motor in which a shaft having high impact resistance is fixed to the hard disk drive has been used. That is, the fixed shaft-type spindle motor in which the shaft is fixed has been used in order to prevent a disk having information recorded thereon from being damaged, such that data may not be written thereto or read therefrom due to such an external impact.

In addition, in the fixed shaft-type spindle motor, a structure in which a single liquid-vapor interface is formed in each of upper and lower portions of the bearing clearance has been used.

Meanwhile, durability of the spindle motor is determined depending on an amount of evaporation of lubricating fluid filled in the bearing clearance. That is, when the lubricating fluid filled in the bearing clearance is evaporated by a predetermined amount or more due to the use of the spindle motor during a predetermined period or more, sufficient dynamic pressure is not generated due to an insufficient amount of the lubricating fluid.

In this case, rotational characteristics are deteriorated, such that a lifespan of the spindle motor may be reduced.

Therefore, the development of a structure capable of suppressing evaporation of the lubricating fluid filled in the bearing clearance has been demanded.

### RELATED ART DOCUMENT

(Patent Document 1) Japanese Patent Laid-Open Publication No. 2002-202434

### SUMMARY

An aspect of the present disclosure may provide a spindle motor capable of suppressing evaporation of a lubricating fluid, and a hard disk drive including the same.

According to an aspect of the present disclosure, a spindle motor may include: a shaft having a lower end portion fixed to a lower thrust member and having a flange part disposed at an upper end portion thereof; a rotating member rotating around the shaft and including a sleeve part disposed between the lower thrust member and the flange part; a sealing member fixed to an outer peripheral surface of the flange part of the shaft; a cap member fixed to the rotating member to be disposed to face the sealing member; and a cover member having a region surrounding a mounting hole seated on an upper surface of the flange part of the shaft and forming a labyrinth seal together with the cap member.

The cover member may be provided with a step part for forming a labyrinth seal together with the cap member.

The cap member may include a fixed part fixed to the rotating member, an inclined part extended from the fixed part and inclined, and a bent part bent from the inclined part.

A distal end of the step part of the cover member may be disposed at an outer side of a distal end of the bent part in a radial direction.

The rotating member may have a sealing groove formed therein, the sealing groove having a lower end portion of the sealing member inserted thereinto.

The sealing member may have an inclined surface formed at the lower end portion thereof to form a liquid-vapor interface together with the rotating member.

The pumping groove may be formed in a region of the step part disposed to face the cap member.

According to another aspect of the present disclosure, a hard disk drive may include: the spindle motor as described above, rotating a recording disk; a heat transfer part transferring a head detecting information of the recording disk mounted on the spindle motor to the recording disk; and a base member having the spindle motor and the head transfer part installed thereon.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view illustrating a hard disk drive according to an exemplary embodiment of the present disclosure;

FIG. 2 is a schematic cross-sectional view illustrating a spindle motor according to an exemplary embodiment of the present disclosure;

FIG. 3 is an enlarged view illustrating part A of FIG. 2; and

FIG. 4 is an enlarged view illustrating a region corresponding to FIG. 3 in a spindle motor according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

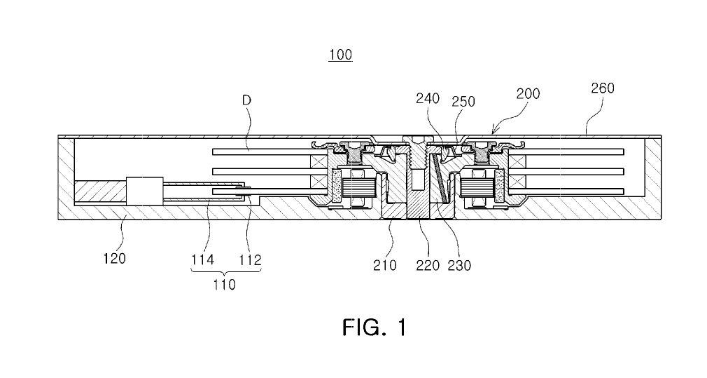

FIG. 1 is a schematic cross-sectional view illustrating a hard disk drive according to an exemplary embodiment of the present disclosure.

Referring to FIG. 1, a hard disk drive 100 according to an exemplary embodiment of the present disclosure may include a spindle motor 200, a heat transfer part 110, and a base member 120.

The spindle motor 200 may be installed on the base member 120 and serve to rotate a recording disk D.

Meanwhile, detailed contents for the spindle motor 200 will be described later.

The heat transfer part 110 may transfer a head 112, reading information from the recording disk D mounted on the spindle motor 200, to a surface of the recording disk D on which the information is to be detected. The head 112 may be disposed on a support part 114 of the head transfer part 110.

The base member 120 may form, together with a cover member 260 of a spindle motor 200 to be described below, an internal space in which the spindle motor 200 and the head transfer part 110 are accommodated. That is, the base member 120 may form, together with the cover member 260, an outer casing of the hard disk drive 100.

Detailed contents for the base member 120 will be again described in a description of a spindle motor 200 to be provided later.

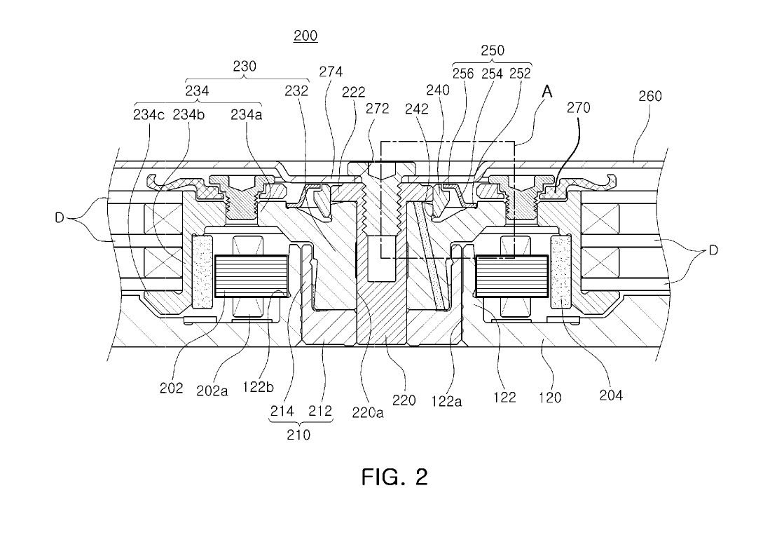

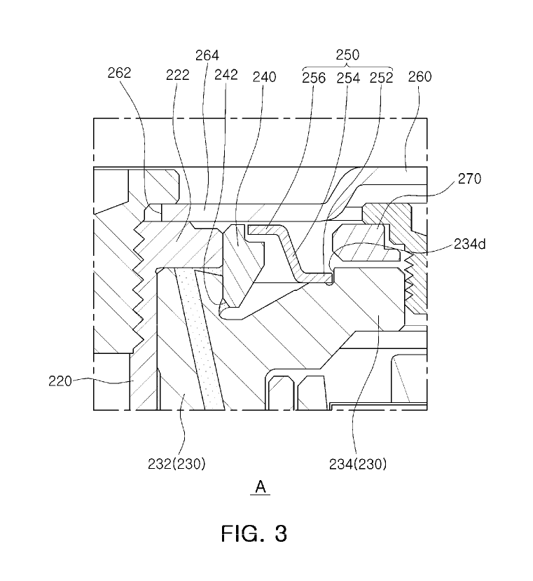

FIG. 2 is a schematic cross-sectional view illustrating a spindle motor according to an exemplary embodiment of the present disclosure; and FIG. 3 is an enlarged view illustrating part A of FIG. 2.

Referring to FIGS. 2 and 3, a spindle motor 200 according to an exemplary embodiment of the present disclosure may include a lower thrust member 210, a shaft 220, a rotating member 230, a sealing member 240, a cap member 250, and a cover member 260 by way of example.

Meanwhile, the lower thrust member 210 may be fixed to the base member 120.

Here, the base member 120 will be described. The base member 120 may include an installation part 122 on which a stator core 202 is installed. The installation part 122 may be provided with an installation hole 122a into which the above-mentioned lower thrust member 210 is inserted and may be extended in an upward axial direction.

Here, terms with respect to directions will be defined. As viewed in FIG. 2, an axial direction refers to a vertical direction, that is, a direction from a lower end portion of the shaft 220 toward an upper end portion thereof or a direction from the upper end portion of the shaft 220 toward the lower end portion thereof, and a radial direction refers to a horizontal direction, that is, a direction from the shaft 220 toward an outer peripheral surface of the rotating member 230 or from the outer peripheral surface of the rotating member 230 toward the shaft 220.

In addition, a circumferential direction refers to a rotation direction along the outer peripheral direction of the shaft 220.

Meanwhile, the installation part 122 may have a support surface 122b formed on an outer peripheral surface thereof to support the stator core 202. As an example, the stator core 202 may be fixed to the installation part 122 in a state in which it is seated on the support surface 122b of the installation part 122.

The lower thrust member 210 may be inserted into the installation hole 122a of the installation part 122 and may have an outer peripheral surface bonded to an inner peripheral surface of the installation part 122. Here, the lower thrust member 210 may be fixed to the installation part 122 by at least one of an adhering method, a press-fitting method, and a welding method.

Meanwhile, the lower thrust member 210 may have a disk shape and include a disk part 212 having a through-hole 212a formed therein and a sealing wall part 214 extended from an edge of the disk part 212 in the upward axial direction, wherein the through-hole 212a has a lower end portion of the shaft 220 inserted thereinto.

In addition, the lower thrust member 210 may serve to allow an interface between a lubricating fluid and air (that is, a liquid-vapor interface) to be formed together with the rotating member 230.

Meanwhile, the sealing wall part 214 may form, together with the rotating member 230, a labyrinth seal. That is, an inner peripheral surface of the sealing wall part 214 and a facing surface of the rotating member 230 disposed to face the inner peripheral surface of the sealing wall part 214 may be disposed to be spaced apart from each other by a predetermined interval, thereby forming the labyrinth seal. Therefore, leakage of air containing evaporated lubricating fluid to the outside through a space formed by the inner peripheral surface of the sealing wall part 214 and the facing surface of the rotating member 230 disposed to face the inner peripheral surface of the sealing wall part 214 may be decreased.

The shaft 220 may have a lower end portion fixed to the lower thrust member 210 and have a flange part 222 disposed at an upper end portion thereof. As an example, the lower end portion of the shaft 220 may be inserted into the through-hole 212a of the lower thrust member 210 to thereby be fixed to the lower thrust member 210. That is, the spindle motor 200 according to an exemplary embodiment of the present disclosure may have a fixed shaft structure in which the shaft 220 is fixed.

Meanwhile, the shaft 220 may form, together with the rotating member 230, a bearing clearance in which the lubricating fluid is filled.

In addition, the flange part 222 may have a liquid-vapor interface formed by the flange part 222 and the rotating member 230 at a lower end portion of an outer peripheral surface thereof.

That is, one of the liquid-vapor interfaces may be formed in a space formed by the lower thrust member 210 and the rotating member 230, and the other of the liquid-vapor interfaces may be formed in a space formed by the flange part 222 and the rotating member 230.

The rotating member 230 may rotate around the shaft 220 and include a sleeve part 232 disposed between the lower thrust member 210 and the flange part 222.

In addition, the rotating member 230 may have a sealing groove 231 formed therein, wherein the sealing groove 231 has a lower end portion of the sealing member 240 inserted thereinto.

Further, the sleeve part 232 of the rotating member 230 may form, together with the shaft 220 and the lower thrust member 210, a bearing clearance in which the lubricating fluid is filled. That is, the sleeve part 232 may be a portion of the rotating member 230 disposed between the flange part 222 of the shaft 220 and the disk part 212 of the lower thrust member 210, in other words, a portion of the rotating member 230 forming the bearing clearance.

Meanwhile, the sleeve part 232 may have a shaft hole 232a formed therein, wherein the shaft hole 232a has the shaft 220 penetrating therethrough. In addition, the rotating member 230 may rotate around the shaft 220 inserted into the shaft hole 232a of the sleeve part 232.

Further, upper and lower radial dynamic grooves (not shown) may be formed in at least one of an inner peripheral surface of the sleeve part 232 and the outer peripheral surface of the shaft 220. The upper and lower radial dynamic grooves may be disposed to be spaced apart from each other by a predetermined interval in the axial direction and generate fluid dynamic pressure in the radial direction at the time of rotation of the sleeve part 232.

As described above, the rotating member 230 may more stably rotate by the fluid dynamic pressure generated by the upper and lower radial dynamic grooves.

Meanwhile, the rotating member 230 may include a rotor hub part 234 extended from the sleeve part 232. The rotor hub part 234 may include a body 234a having a disk shape, a magnet mounting part 234b extended from an edge of the body 234a in a downward axial direction, and a disk supporting part 234c extended from a distal end of the magnet mounting part 234b in the radial direction.

In addition, the magnet mounting part 234b may include a driving magnet 204 fixed to an inner surface thereof. Therefore, an inner surface of the driving magnet 204 may be disposed to face a front end of the stator core 202.

In addition, the driving magnet 204 may be a permanent magnet generating magnetic force having predetermined strength by alternately magnetizing an N pole and an S pole in the circumferential direction.

Here, a rotation scheme of the rotating member 230 will be briefly described. When power is supplied to a coil 202a wound around the stator core 202, driving force rotating the rotating member 230 may be generated by electromagnetic interaction between the stator core 202 having the coil 202a wound therearound and the driving magnet 204, such that the rotating member 230 may rotate.

That is, the rotating member 230 may rotate by the electromagnetic interaction between the driving magnet 204 and the stator core 202 disposed to face the driving magnet 204 and having the coil 202a wound therearound.

Meanwhile, a clamp 270 for fixing the disk D may be fixed to the rotor hub part 234 by a screw.

The sealing member 240 may be fixed to the outer peripheral surface of the flange part 222 of the shaft 220. Meanwhile, the sealing member 240 may serve to form, together with the rotating member 230, a liquid-vapor interface. To this end, the sealing member 240 may have an inclined surface 242. That is, the liquid-vapor interface may be disposed in a space formed by the inclined surface 242 and a facing surface of the rotating member 230 disposed to face the inclined surface 242.

Meanwhile, in the case which the sealing member 240 is installed on the shaft 220, a lower end portion of the sealing member 240 may be inserted into the sealing groove 231 of the rotating member 230.

The cap member 250 may be fixed to the rotating member 230 to be disposed to face the sealing member 240. As an example, the cap member 250 may be fixed to a bonding groove 234d formed in the rotor hub part 234 of the rotating member 230.

Meanwhile, the cap member 250 may include a fixed part 252 fixed to the rotating member 230, an inclined part 254 extended from the fixed part 252 and inclined, and a bent part 256 bent from the inclined part 254.

In addition, the cap member 250 may serve to prevent a leaked lubricating fluid from being scattered in the case in which the lubricating fluid is leaked from the bearing clearance. To this end, a distal end of the bent part 256 may be disposed above the sealing member 240.

The cover member 260 may be coupled to the shaft 220. To this end, the cover member 260 may have a mounting hole 262 formed therein. Meanwhile, a region surrounding the mounting hole 262 of the cover member 260 may be seated on an upper surface of the flange part 222 of the shaft 220, and the cover member 260 and the shaft 220 may be coupled to each other by screw-coupling therebetween.

Meanwhile, the cover member 260 may be provided with a step part 264 for forming a labyrinth seal together with the cap member 250. A distal end of the step part 264 may be formed of a groove disposed at an outer side of a distal end of the bent part 256 in the radial direction. That is, the cover member 260 and the cap member 250 may form the labyrinth seal by the step part 264. Therefore, the leakage of the air containing the evaporated lubricating fluid to the outside through a space between the cover member 260 and the cap member 250 may be decreased.

As a result, the evaporation of the lubricating fluid may be further suppressed through the labyrinth seal formed by the cover member 260 and the cap member 250. In other words, the evaporation of the lubricating fluid may be decreased as compared with the case in which the step part 264 is not formed in the cover member 260.

As described above, the labyrinth seals may be formed by the lower thrust member 210 and the rotating member 230 and by the cover member 260 and the cap member 250 to suppress the evaporation of the lubricating fluid.

Hereinafter, an operation of the spindle motor 200 according to an exemplary embodiment of the present disclosure will be described with reference to FIGS. 2 and 3.

First, the spindle motor 200 according to an exemplary embodiment of the present disclosure may have two liquid-vapor interfaces. That is, one of the two liquid-vapor interfaces may be disposed in the space formed by the lower thrust member 210 and the rotating member 230. In addition, an upper end portion of the sealing wall part 214 of the lower thrust member 210 and a facing part of the rotating member 230 disposed to face the upper end portion of the sealing wall part 214 of the lower thrust member 210 may form a labyrinth seal.

Therefore, the evaporation of the lubricating fluid may be suppressed.

In addition, the other of the two liquid-vapor interfaces may be disposed in the space formed by the sealing member 240 and the rotating member 230. That is, the other of the two liquid-vapor interfaces may be disposed in the space formed by the inclined surface 242 of the sealing member 240 and the facing surface of the rotating member 230 disposed to face the inclined surface 242.

In addition, the cap member 250 and the cover member 260 may form the labyrinth seal in order to suppress the evaporation of the lubricating fluid through the liquid-vapor interface. That is, the step part 264 may be formed in the cover member 260 to form the labyrinth seal together with the bent part 256 of the cap member 250, thereby suppressing the evaporation of the lubricating fluid from the liquid-vapor interface disposed in the space formed by the sealing member 240 and the rotating member 230.

As described above, the spindle motor 200 according to an exemplary embodiment of the present disclosure may be provided with the labyrinth seals in order to suppress the evaporation of the lubricating fluid from the liquid-vapor interfaces, thereby further suppressing the evaporation of the lubricating fluid.

As a result, a lifespan of the spindle motor 200 may be increased, such that durability of the spindle motor 200 may be improved.

Hereinafter, a spindle motor according to another exemplary embodiment of the present disclosure will be described with reference to the accompanying drawings. However, a detailed description for the same components as the above-mentioned components will be omitted and be replaced by the above-mentioned description.

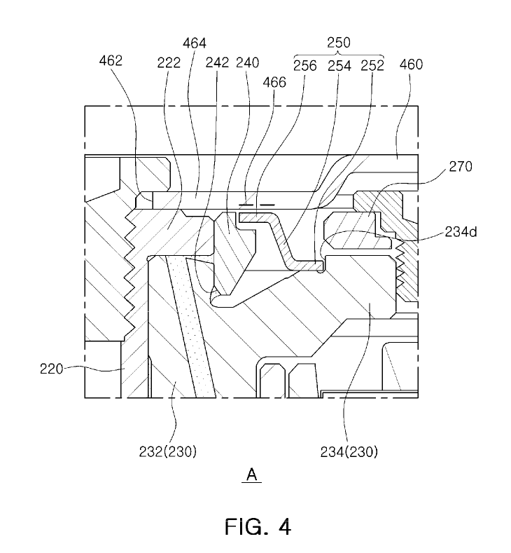

FIG. 4 is an enlarged view illustrating a region corresponding to FIG. 3 in a spindle motor according to another exemplary embodiment of the present disclosure.

Referring to FIG. 4, a cover member 460 may be coupled to the shaft 220. To this end, the cover member 460 may have a mounting hole 462 formed therein. Meanwhile, a region surrounding the mounting hole 462 of the cover member 460 may be seated on an upper surface of the flange part 222 of the shaft 220, and the cover member 460 and the shaft 220 may be coupled to each other by screw-coupling therebetween.

Meanwhile, the cover member 460 may be provided with a step part 464 for forming a labyrinth seal together with the cap member 250. A distal end of the step part 464 may be formed of a groove disposed at an outer side of a distal end of a bent part 456 in the radial direction. That is, the cover member 460 and the cap member 250 may form the labyrinth seal by the step part 464. Therefore, the leakage of the air containing the evaporated lubricating fluid to the outside through a space between the cover member 460 and the cap member 250 may be decreased.

As a result, the evaporation of the lubricating fluid may be further suppressed through the labyrinth seal formed by the cover member 460 and the cap member 250. In other words, the evaporation of the lubricating fluid may be decreased as compared with the case in which the step part 464 is not formed in the cover member 460.

Further, the cover member 460 may have a pumping groove 466 formed in the step part 464 thereof in order to suppress the leakage of the air. As an example, the pumping groove 466 may be formed in a region of the step part 464 disposed to face the cap member 250. That is, the pumping groove 466 may be formed in a region of the step part 464 disposed to face the bent part 256 of the cap member 250. In addition, a length of the pumping groove 466 in the radial direction may be longer than that of the bent part 256.

Therefore, dynamic pressure may be generated at the time of the rotation of the rotating member 230, such that the air may be pumped in an inner diameter direction. As a result, the leakage of the air may be decreased to further suppress the evaporation of the lubricating fluid.

As described above, the spindle motor according to another exemplary embodiment of the present disclosure may be provided with the pumping groove 466 as well as the labyrinth seals, thereby further suppressing the evaporation of the lubricating fluid as compared with the spindle motor 200 according to an exemplary embodiment of the present disclosure.

As set forth above, according to exemplary embodiments of the present disclosure, the labyrinth seal may be formed by the step part formed in an upper case to suppress the evaporation of the lubricating fluid.

In addition, since the leakage of the air containing the evaporated lubricating fluid may be decreased by the pumping groove formed in the case member, the evaporation of the lubricating fluid may be further suppressed.

While exemplary embodiments have been shown and described above, it will be apparent to those skilled in the art that modifications and variations could be made without departing from the scope of the present invention as defined by the appended claims.

What is claimed is:

1. A spindle motor comprising:
a shaft having a lower end portion fixed to a lower thrust member and having a flange part disposed at an upper end portion thereof;
a rotating member rotating around the shaft and including a sleeve part disposed between the lower thrust member and the flange part;
a sealing member fixed to an outer peripheral surface of the flange part of the shaft;
a cap member fixed to the rotating member to be disposed to face the sealing member; and
a cover member having a region surrounding a mounting hole seated on an upper surface of the flange part of the shaft and forming a labyrinth seal together with the cap member.

2. The spindle motor of claim 1, wherein the cover member is provided with a step part for forming a labyrinth seal together with the cap member.

3. The spindle motor of claim 2, wherein the cap member includes a fixed part fixed to the rotating member, an inclined part extended from the fixed part and inclined, and a bent part bent from the inclined part.

4. The spindle motor of claim 3, wherein a distal end of the step part of the cover member is disposed at an outer side of a distal end of the bent part in a radial direction.

5. The spindle motor of claim 1, wherein the rotating member has a sealing groove formed therein, the sealing groove having a lower end portion of the sealing member inserted thereinto.

6. The spindle motor of claim 5, wherein the sealing member has an inclined surface formed at the lower end portion thereof to form a liquid-vapor interface together with the rotating member.

7. The spindle motor of claim 2, wherein the step part has a pumping groove formed therein in order to suppress leakage of air.

8. The spindle motor of claim 7, wherein the pumping groove is formed in a region of the step part disposed to face the cap member.

9. The spindle motor of claim 8, wherein a distal end of the step part of the cover member is disposed at an outer side of a distal end of the bent part in a radial direction.

10. A hard disk drive comprising:
the spindle motor of claim 1 rotating a recording disk;
a heat transfer part transferring a head detecting information of the recording disk mounted on the spindle motor to the recording disk; and
a base member having the spindle motor and the head transfer part installed thereon.
